(19) United States
(12) Patent Application Publication
(10) Pub. No.: US 2013/0216051 A1
(43) Pub. Date: Aug. 22, 2013

(54) ACOUSTIC APPARATUS

(71) Applicant: DENSO CORPORATION, (US)

(72) Inventor: Koichi GOTO, Kariya-city (JP)

(73) Assignee: DENSO CORPORATION, Kariya-city (JP)

(21) Appl. No.: 13/765,116

(22) Filed: Feb. 12, 2013

(30) Foreign Application Priority Data
Feb. 16, 2012 (JP) 2012-31831
Mar. 21, 2012 (JP) 2012-64299

(51) Int. Cl. H04R 29/00

(52) U.S. Cl. CPC H04R 29/001
USPC 381/59

(57) ABSTRACT

An acoustic apparatus includes: a plurality of speakers, which are connected in parallel to each other; and a line break detector for detecting the number of line break in the speakers. The line break detector includes: a detection voltage generator for applying a reference voltage to the speakers; and a line break determination device for determining the number of line break according to an actual voltage of the speakers when the reference voltage is applied to the speakers or when application of the reference voltage to the speakers is stopped. Thus, without using an impedance measurement device, the number of line break is calculated based on the actual voltage of the speakers. The number of line break in the speakers is easily detected with low manufacturing cost.

### CROSS REFERENCE TO RELATED APPLICATIONS

This application is based on Japanese Patent Applications No. 2012-31831 filed on Feb. 16, 2012, and No. 2012-64299 filed on Mar. 21, 2012, the disclosures of which are incorporated herein by reference.

### TECHNICAL FIELD

The present disclosure relates to an acoustic apparatus having multiple speakers, which are connected in parallel to each other. The apparatus detects the number of speakers that functions normally.

### BACKGROUND

An acoustic apparatus having a line break detector for detecting the number of speakers, of which a line breaks, is described in JP-A-H09-307988. The acoustic apparatus includes multiple speakers, which are connected in parallel to each other.

The acoustic apparatus further includes: a power amplifier for driving each speaker according to an input signal; a first voltage converter for converting an output signal from the power amplifier to a high impedance signal; a second voltage converter disposed at each speaker and converting the high impedance signal to a low impedance signal; and an impedance measurement device for measuring an output impedance from the first voltage converter.

The number of broken lines is detected based on the impedance value measured by the impedance measurement device when a test signal is input into the power amplifier.

However, the impedance measurement device for measuring the impedance is large in the dimensions, complicated, and expensive.

Accordingly, it is not easy to detect the number of broken lines in the speaker. Specifically, it is difficult to minimize the dimensions and to reduce the price of the impedance measurement device. Thus, it is difficult to mount the impedance measurement device on a vehicle.

### SUMMARY

It is an object of the present disclosure to provide an acoustic apparatus for detecting the number of broken lines in multiple speakers without using an impedance measurement device, which is expensive. Thus, a manufacturing cost of the acoustic apparatus is low.

An acoustic apparatus includes: a plurality of speakers, which are connected in parallel to each other; and a line break detector for detecting the number of line break in the speakers. The line break detector includes: a detection voltage generator for applying a reference voltage to the speakers; and a line break determination device for determining the number of line break according to an actual voltage of the speakers when the reference voltage is applied to the speakers or when application of the reference voltage to the speakers is stopped. Thus, without using an impedance measurement device, the number of line break is calculated based on the actual voltage of the speakers. The number of line break in the speakers is easily detected with low manufacturing cost.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a vehicle-existence alert apparatus according to a first embodiment;

FIG. 2 is a diagram showing a graph of a waveform of an input signal and an output signal of a digital amplifier (class-D amplifier) when an alert sound is output;

FIG. 3A is a graph showing a waveform of a voltage to be applied to multiple speakers and an actual voltage in the speakers when the apparatus detects a line break, and FIG. 3B is a graph showing a relationship between the actual voltage of the speakers and the number of speakers, which functions normally, after predetermine time elapsed;

FIG. 4 is a diagram showing a front view of a vehicle horn including a Piezo electric speaker;

FIG. 5A is a graph showing a waveform of a voltage to be applied to multiple speakers and an actual voltage in the speakers when the apparatus detects a line break, and FIG. 5B is a graph showing a relationship between the time interval and the number of speakers, which functions normally, the time interval being defined by time elapsed until the actual voltage of multiple speakers reaches a predetermined voltage, according to a second embodiment;

FIG. 6 is a diagram showing a vehicle-existence alert apparatus according to a third embodiment;

FIG. 7 is a diagram showing a front view of a vehicle horn including a Piezo electric speaker according to the third embodiment;

FIG. 8 is a graph showing a determination index value depending on temperature according to the third embodiment;

FIG. 9A is a graph showing a waveform of a voltage to be applied to multiple speakers and an actual voltage in the speakers when the apparatus detects a line break, and FIG. 9B is a graph showing a relationship between the actual voltage of the speakers and the number of speakers, which functions normally, after predetermine time elapsed, according to the third embodiment;

FIG. 10A is a graph showing a waveform of a voltage to be applied to multiple speakers and an actual voltage in the speakers when the apparatus detects a line break, and FIG. 10B is a graph showing a relationship between the time interval and the number of speakers, which functions normally, the time interval being defined by time elapsed until the actual voltage of multiple speakers reaches a predetermined voltage, according to a fourth embodiment; and

FIG. 11 is a diagram showing a vehicle-existence alert apparatus according to a fifth embodiment.

### DETAILED DESCRIPTION

Embodiments will be explained with reference to drawings.

An acoustic apparatus, for example, a vehicle-existence alert apparatus, includes a line break detector 2 for detecting the number of broken lines in multiple speakers 1, which are connected in parallel to each other. Here, each speaker is, for example, a capacitive speaker such as a Piezo electric speaker and a capacitance speaker.

The line break detector 2 includes a detection voltage generator 4 and a voltage measurement device 5 and a line break determination device 6. The detection voltage generator 4 inputs a crest voltage having a PWM waveform into a digital amplifier 3 (i.e., class-D amplifier) when a condition of line break detection is satisfied (i.e., a line break state is detected), so that a reference voltage Vi is applied to each speaker 1 via the amplifier 3. The amplifier 3 drives each speaker 1. The voltage measurement device 5 measures an actual voltage Vo of each speaker 1 when the line break state is detected. The line break determination device 6 determines the number of broken lines or the number of normal speakers according to the actual voltage Vo of the speaker 1 after the reference voltage Vi is applied to the speaker 1 or just after the application of the reference voltage Vi to the speaker 1 is stopped. Here, the actual voltage Vo is detected by the voltage measurement device 5.

An example embodiment of the present disclosure will be explained with reference to the drawings.

### First Embodiment

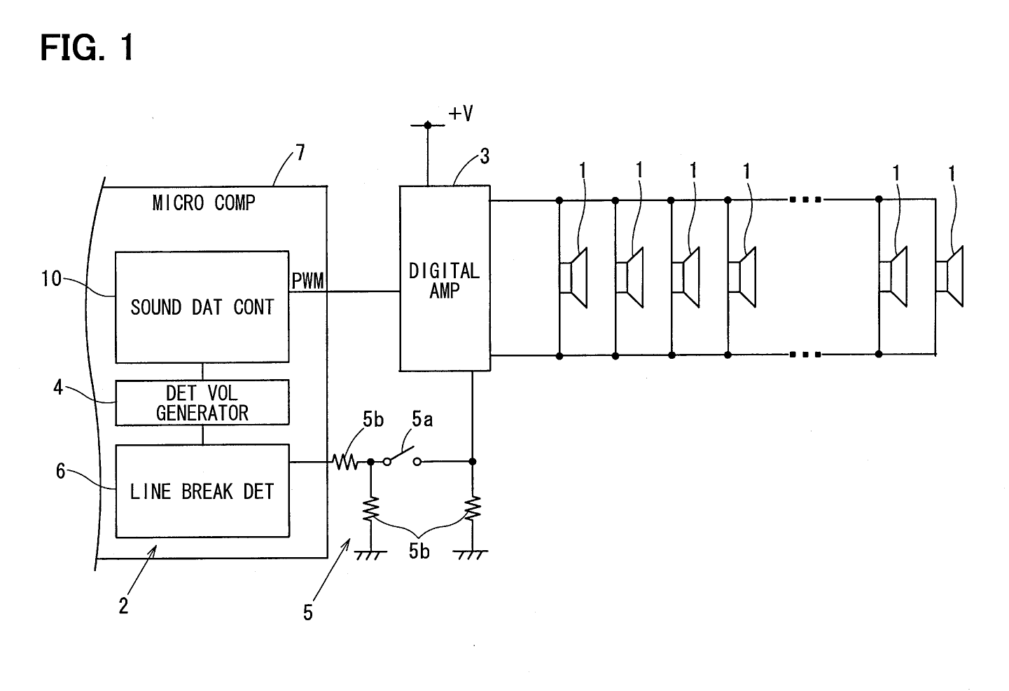

A first embodiment will be explained with reference to FIGS. 1 to 4.

The vehicle-existence alert apparatus is mounted on a vehicle having a comparatively small vehicle noise when the vehicle runs or stops at a traffic light, for example. The vehicle is, for example, a vehicle without an internal combustion engine such as an electric vehicle and a fuel cell vehicle, or a vehicle such as a hybrid vehicle which stops an internal combustion engine when the vehicle runs or stops at a traffic light, for example.

The vehicle existence alert apparatus outputs an alert sound such as a pseudo engine sound, a chord sound, a voice message, and a music so that the apparatus informs a pedestrian of the existence of the vehicle when a driving condition for informing the existence of the vehicle is satisfied.

The apparatus includes: multiple speakers 1, which are connected in parallel to each other; a digital amplifier 3 for driving the speakers 1; and a micro computer 7 for inputting an input signal having a PWM waveform to the digital amplifier 3.

Each speaker 1 is, for example, a Piezo electric speaker having a small size, which includes a Piezo electric element and a vibration plate. The Piezo electric element extends and contracts in accordance with an applied voltage (i.e., charging and discharging electricity). The vibration plate generates a compression wave in air when the Piezo electric element extends and contracts so as to vibrate the air. The Piezo electric speaker is a kind of a capacitive speaker.

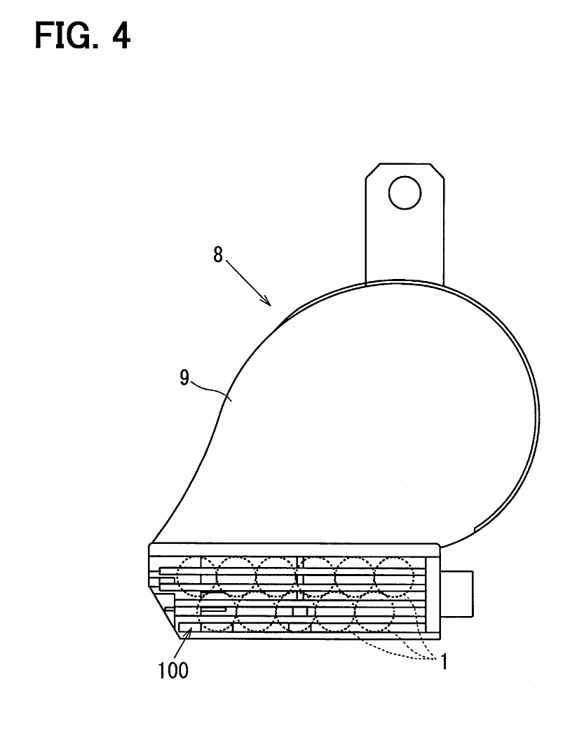

The mounting positions and the mounting manner of the speakers 1 are not limited. One of examples of the mounting positions and the mounting manner of the speakers 1 is shown in FIG. 4.

The speakers 1 in FIG. 4 are arranged at an acoustic outlet (a sound output portion) 100 of a swirl type horn 9 in a vehicle horn device 8. Specifically, the speakers 1 are arranged on a rear side of the acoustic outlet 100 of the horn 9. An acoustic wave generating direction of each speaker 1 is in parallel to a front direction. The speakers 1 are densely arranged so as to provide a speaker array.

The horn device 8 is fixed to an inside of a front grille (i.e., a fresh-air intake while running), which is disposed on a front side of the vehicle. When a passenger of the vehicle operates a horn switch, the horn device 8 generates and outputs a warning sound.

When vehicle information indicative of a driving condition of the vehicle such as vehicle speed signal is input into the micro computer 7 from an ECU (i.e., engine control unit), and the driving condition for informing the existence of the vehicle is satisfied (for example, when the vehicle speed is equal to or smaller than 20 km/h), the computer 7 provides an operation signal to the digital amplifier 3 so that multiple speakers 1 generate the alert sound.

Specifically, the micro computer 7 includes a sound data control element 10, which provides a control program. When the generation condition of the alert sound is satisfied, the element 10 generates a PWM sound signal having a PWM waveform, which is prepared by modulating the alert sound (i.e., an audible sound signal) with a PWM method. Then, the element 10 provides the PWM sound signal to the digital amplifier 3.

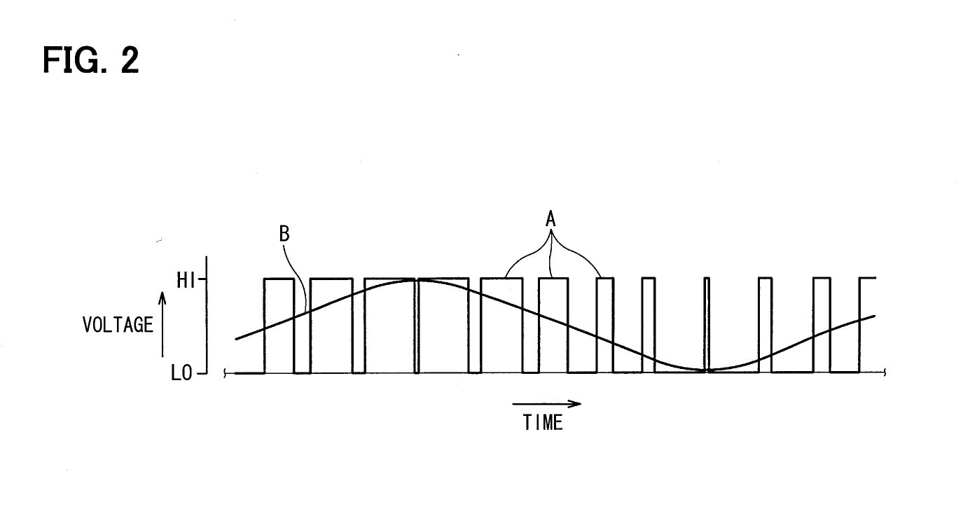

The digital amplifier 3 converts the PWM waveform (which is shown as a solid line A in FIG. 2) obtained by the sound data control element 10 to an analog waveform (which is shown as a solid line B in FIG. 2), so as to drive the speakers 1. For example, the digital amplifier 3 is a conventional amplifier including a switching circuit and a filter circuit.

The vehicle existence alert apparatus according to the present embodiment further includes a line break detector 2 for detecting the number of broken lines in the speakers 1, which are connected in parallel to each other.

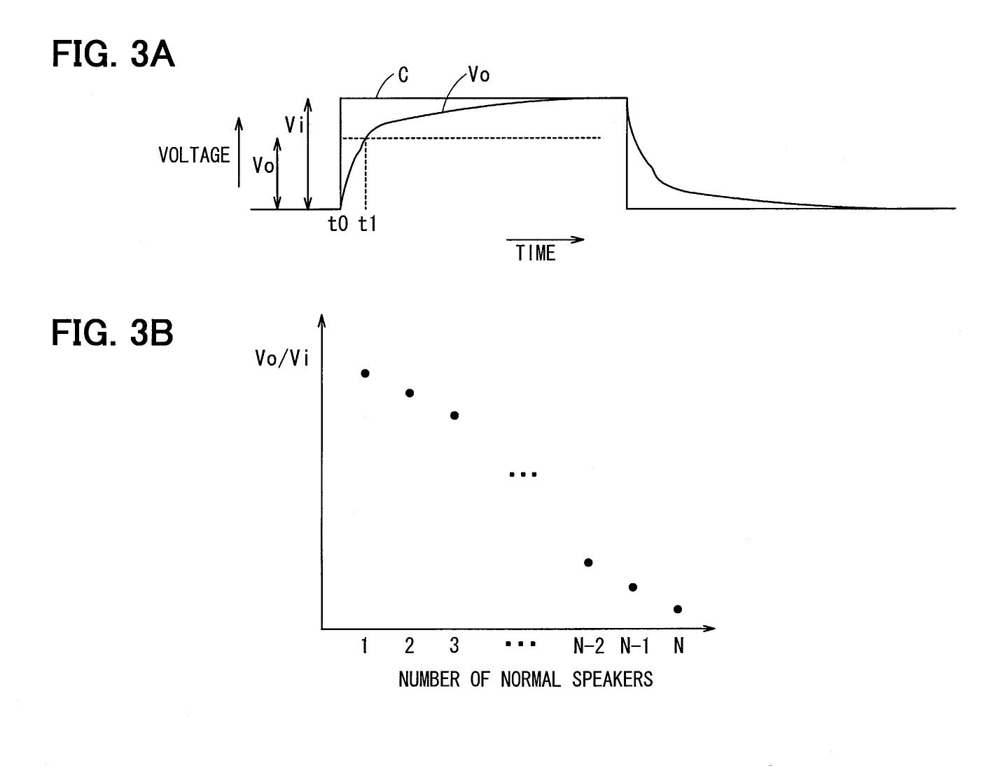

The line break detector 2 includes a detection voltage generator 4 and a line break determination element 6. The detection voltage generator 4 inputs a high signal as a wave-height voltage having the PWM waveform into the digital amplifier 3 for driving multiple speakers 1 when a condition for detecting the line break is satisfied, i.e., when a line break detection step is executed. Thus, the generator 4 applies a reference voltage Vi (shown as a solid line C in FIG. 3) to the speakers 1 via the amplifier 3. The generator 4 provides an instruction element for controlling the sound data controller 10 to output the wave-height signal from the sound data controller 10. The line break determination device 6 determines the number of broken lines according to an actual voltage Vo (i.e., an actual voltage of speakers 1) after the reference voltage Vi is applied to the speakers 1, or after the application of the reference voltage vi to the speakers 1 is stopped. The line break determination device 6 provides a control program.

A control device including the micro computer 7 and the digital amplifier 3 further includes a voltage measurement element 5 for measuring the actual voltage Vo of the speakers 1, which is connected in parallel to each other. For example, the element 5 measures an output voltage of the digital amplifier 3.

The voltage measurement element 5 includes a switch 5a and multiple resistors 5b. The micro computer 7 turns on the switch 5a when the line break state detection step is executed, so that the actual voltage Vo is applied to the line break determination device 6 when the line break state detection step is executed.

Here, the reference voltage Vi to be applied to the speakers 1 at the line break state detection step is a direct current voltage, which saturates all of capacitances of the speakers 1.

The reference voltage Vi according to the present embodiment is generated by applying the wave-height signal voltage having the PWM waveform to the digital amplifier 3.

Specifically, the detection voltage generator 4 inputs the instruction signal to the sound data controller 10 in the line break state detection step so that the sound data controller 10 applies the wave-height voltage having the PWM waveform to the digital amplifier 3 for a predetermined time period (i.e., an implementation period of the line break detection).

The line break determination device 6 measures the actual voltage Vo of the speakers 1 at time t1 when a predetermined time has elapsed from the time t0, at which the digital amplifier 3 applies the reference voltage Vi to the speakers 1. The device 6 obtains the number of speakers 1, which function normally, according to the ratio (i.e., Vo/Vi) between the reference voltage Vi and the actual voltage Vo. Here, the number of normal speakers 1 corresponds to the number of speakers 1, in which a line is not broken.

Specifically, the data of the number of normal speakers 1 with respect to the ratio Vo/Vi is preliminary stored in a memory of the micro computer 7. The device 6 obtains the number of normal speakers 1 by comparing the measured ratio Vo/Vi with the data in the memory.

(Effects)

The line break detection element 2 determines the number of broken lines according to the actual voltage Vo after the reference voltage Vi is applied to the speakers 1, which are connected in parallel to each other. Here, the number of broken lines corresponds to the number of normal speakers 1, so that the element 2 substantially obtains the number of normal speakers 1.

Thus, the apparatus can detect the number of broken lines in the speakers 1 based on the actual voltage Vo without using an impedance measurement device, which has large side and is expensive.

As a result, the line break detection element 2 can be mounted on the vehicle. Thus, the vehicle existence alert apparatus with the line break detection element 2 measures the number of broken lines in the speakers 1. The manufacturing cost of the apparatus is low, and the dimensions of the apparatus are comparatively small.

The speakers 1 according to the present embodiment are Peizo electric speakers as the capacitive speakers for generating the acoustic wave according to the change of the accumulated voltage.

Accordingly, the change width of the actual voltage Vo at time t1 with respect to the number of broken lines is comparatively large.

Accordingly, the apparatus can detect the number of broken lines based on the actual voltage Vo with high detection accuracy. Specifically, the vehicle existence alert apparatus can detect the number of broken liens in the speakers 1 with high accuracy.

The line break detection element 2 applies the wave-height voltage having the PWM waveform to the digital amplifier 3 via the sound data controller 10 at the line break state detection step, so that the amplifier 3 generates the reference voltage Vi.

Thus, since the reference voltage Vi is generated according to the wave-height voltage having the PWM waveform, it is not necessary to add a special circuit for generating the reference voltage Vi. Thus, the construction of the line break detection element 2 is simplifier, and therefore, the manufacturing cost of the element 2 is reduced.

(Modifications)

In the present embodiment, the number of broken lines is detected according to the actual voltage Vo at the time t1 when the predetermined time has elapsed from the time t0 at which the reference voltage Vi is applied.

Alternatively, the number of broken lines may be detected according to the actual voltage Vo at the time t1 when the predetermined time has elapsed from the time t0 at which the application of the reference voltage Vi is stopped.

In this case, the above effects in the first embodiment are obtained.

### Second Embodiment

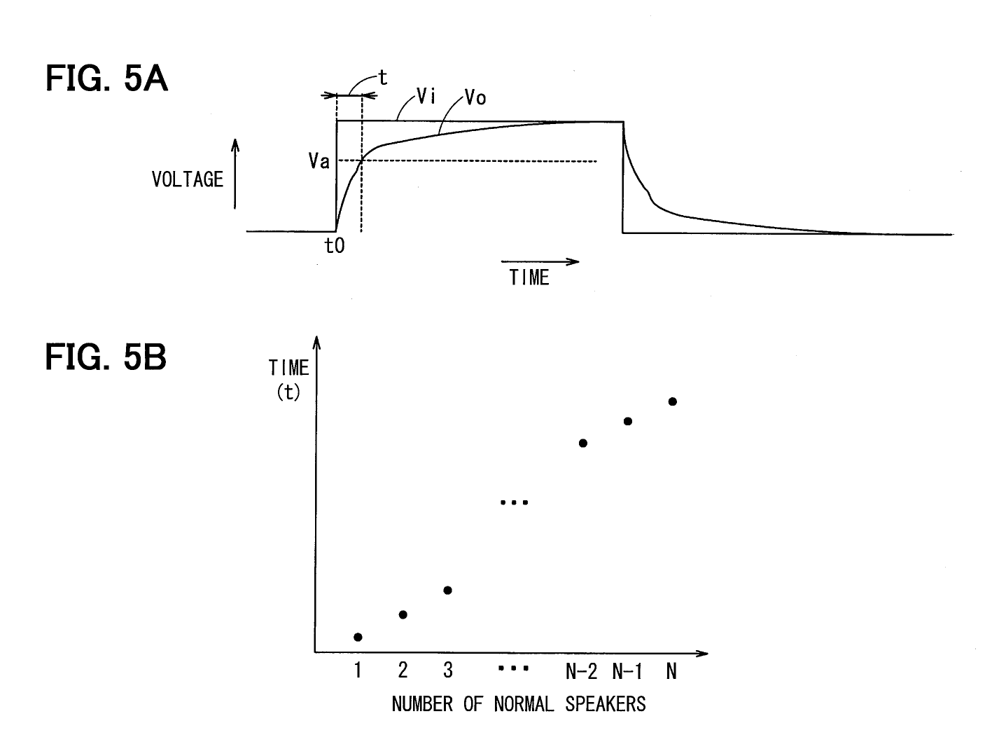

A second embodiment will be explained with reference to FIG. 5.

In the first embodiment, the number of broken lines is detected according to the actual voltage Vo at the time t1 when the predetermined time has elapsed from the time t0 at which the reference voltage Vi is applied, or at which the application of the reference voltage Vi is stopped.

The line break determination device 6 according to the second embodiment determines the number of broken lines according to the time t, at which the actual voltage Vo measured by the voltage measurement device 5 reaches a predetermined voltage Va after the reference voltage Vi is applied to the speakers 1, or after the application of the reference voltage Vi is stopped.

Specifically, the line break determination device 6 measures the time t, at which the actual voltage Vo measured by the voltage measurement device 5 reaches a predetermined voltage Va, from the time to, at which the reference voltage Vi is applied to the speakers 1 via the amplifier 3, as shown in FIG. 5A. Further, the line break determination device 6 provides a program for obtaining the number of normal speakers 1 based on the measured time t, as shown in FIG. 5B. Here, the number of normal speakers 1 is the number of speakers 1, a line of which is not broken.

Specifically, the memory of the micro computer 7 preliminary stores the data about the relationship between the time t and the number of normal speakers 1. Then, the number of normal speakers 1 is calculated by comparing the measured time t at the line break state detection step and the data in the memory. The second embodiment also provides the effects similar to the first embodiment.

(Modifications)

In the above second embodiment, the number of broken lines is calculated based on the time t, at which the actual voltage Vo reaches the predetermined voltage Va, from the time t0, at which the reference voltage Vi is applied.

Alternatively, the number of broken lines may be calculated based on the time t, at which the actual voltage Vo is reduced below a predetermined voltage Va, from the time t0, at which the application of the reference voltage Vi is stopped.

In this case, the effects similar to the first embodiment are obtained.

### Third Embodiment

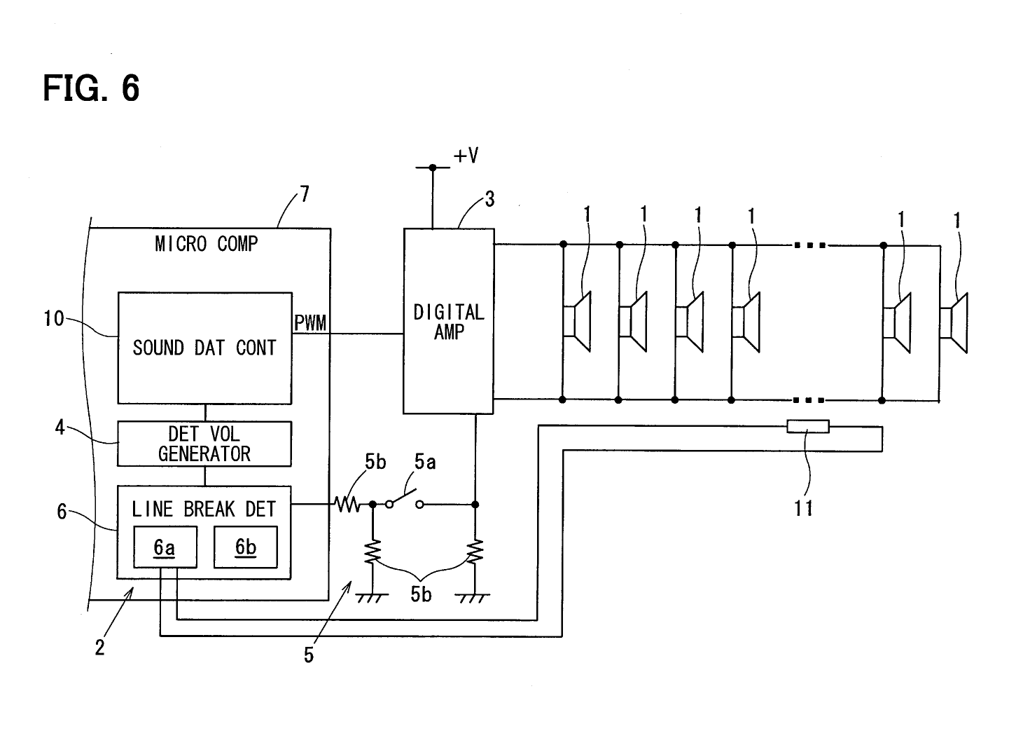

A third embodiment will be explained with reference to FIGS. 6 to 9. In the third embodiment and a fourth embodiment, one of a measurement value to be used for determination of the number of broken lines and a determination index value to be used for the determination of the number of broken lines is corrected according to the temperature of the speakers 1.

Specifically, in the third embodiment, the temperature correction technique is applied to the first embodiment. In the fourth embodiment, the temperature correction technique is applied to the second embodiment.

The line break determination device 6 includes an element for detecting temperature of the speakers 1 directly or indirectly.

The element for detecting the temperature may not be limited. One of examples of the element for detecting the temperature is a thermistor 11 as a temperature sensor for detecting the temperature of the speakers directly. the thermistor 11 has a resistance, which is changeable in accordance with the temperature.

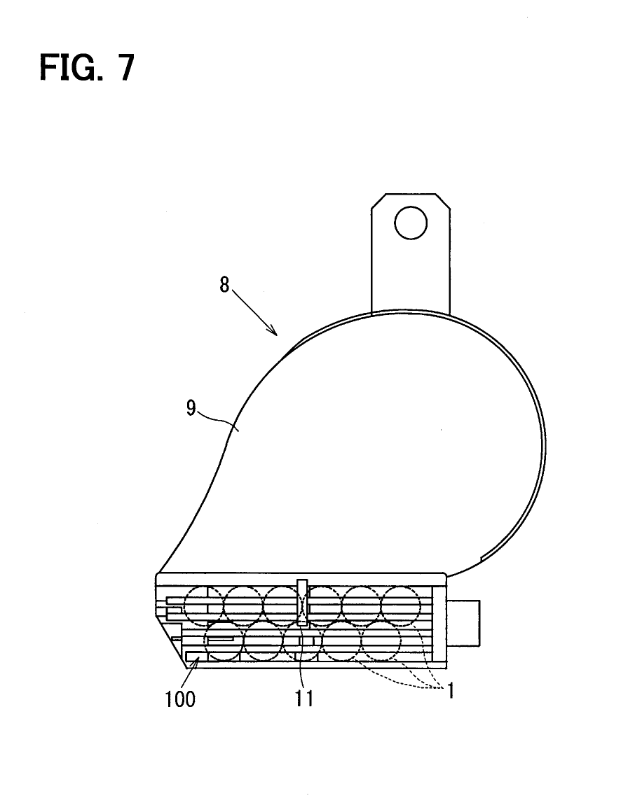

The mounting position of the thermistor 11 may not be limited. The thermistor 11 detects the temperature of each speaker 1 with high accuracy. For example, in the third embodiment, the thermistor 11 is disposed at a center of the speakers 1, as shown in FIG. 7.

The resistance of the thermistor 11 is converted to the temperature by the micro computer 7, specifically, by a temperature calculator 6a of the line break determination device 6.

In the third embodiment, the thermistor 11 provides the element for detecting the temperature of the speakers 1. The element for detecting the temperature may not be limited. For example, the temperature of the external air may be input from other devices such as a ECU or an air-conditioning device. Alternatively, a part of the resisters 5b in the voltage measurement device 5 may be replaced to the thermistor 11.

The correction object according to the third embodiment is the determination index value to be used for the determination of the number of broken lines.

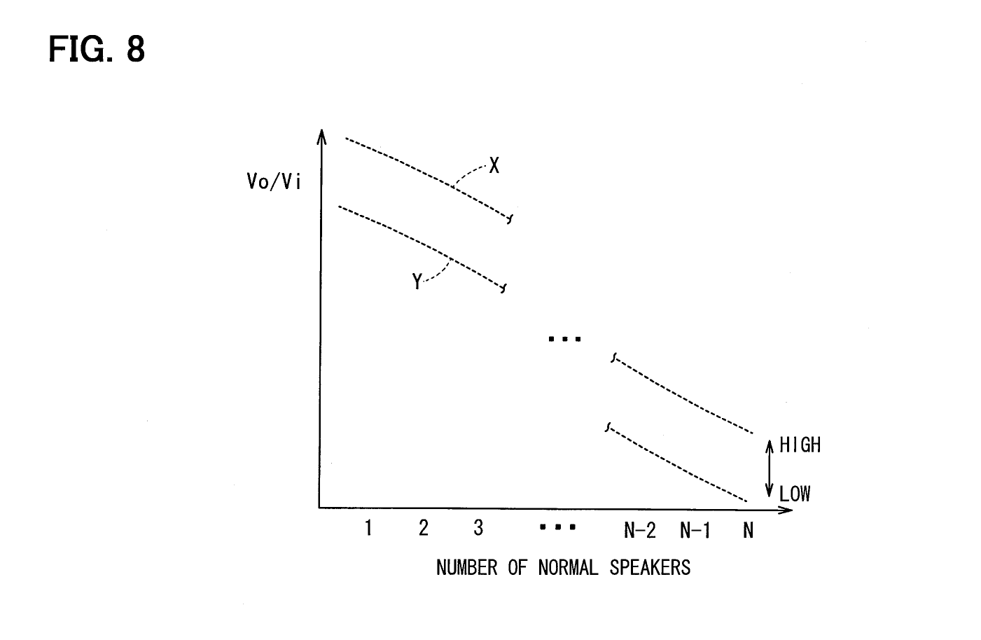

Specifically, in the third embodiment, as shown in FIG. 8, the determination index value to be used for the determination of the broken lines is corrected by the temperature detected by the thermistor 11.

Specifically, as the temperature of each speaker 1 decreases, the determination index value is increased, as shown a broken line X in FIG. 8. As the temperature of each speaker 1 increases, the determination index value is decreased, as shown a broken line Y in FIG. 8.

The correction of the determination index value according to the detected temperature is performed by the micro computer 7, i.e., the temperature correction element 5b of the line break determination device 6.

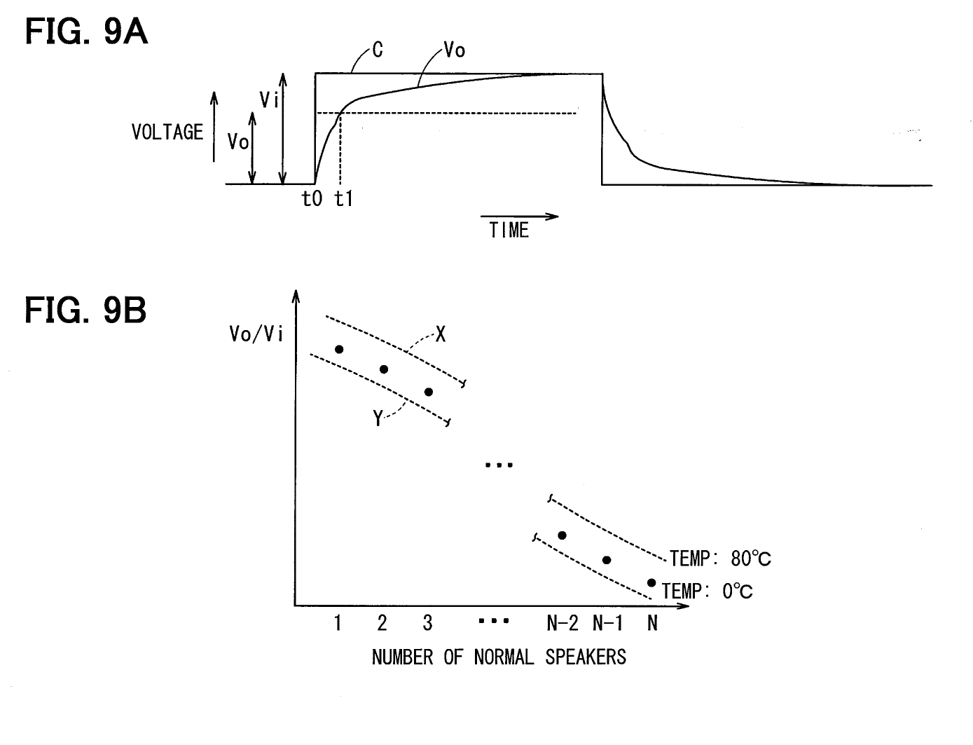

The function of the apparatus according to the third embodiment will be explained with reference to FIG. 9.

When the line break detection condition is satisfied, the line break detection element 2 applies the reference voltage Vi (which corresponds to the solid line C) to the speakers 1 via the amplifier 3, as shown in FIG. 9A.

Then, the line break determination device 6 measures the actual voltage Vo of the speakers 1 at the time t1 when the predetermined time has elapsed from the time t0, at which the reference voltage Vi is applied. Thus, the device 6 obtains the ratio of Vo/Vi.

As shown in FIG. 9B, the line break determination device 6 obtains the number of normal speakers 1 by comparing the calculated ratio of Vo/Vi with the determination index value, which is corrected by the detected temperature.

In the third embodiment, the determination index value is corrected according to the temperature of the speakers 1. Thus, the number of broken lines is obtained with high accuracy even when the temperature of the speakers 1 is varied together with the environmental temperature.

(Modifications)

In the third embodiment, based on the temperature of the speakers 1, the determination index value is corrected. Alternatively, based on the temperature of the speakers 1, the measurement value to be used for the determination of the number of broken lines may be corrected. Specifically, the ratio of Vo/Vi may be corrected.

In the above case, the effects similar to the third embodiment are obtained.

In the third embodiment, the temperature correction technique is applied to the technique for obtaining the number of broken lines based on the ratio of Vo/Vi at the time of starting the energization of the speakers 1.

Alternatively, the temperature correction technique may be applied to the technique for obtaining the number of broken lines based on the ratio of Vo/Vi at the time of stopping the energization of the speakers 1.

In the above case, the effects similar to the third embodiment are obtained.

### Fourth Embodiment

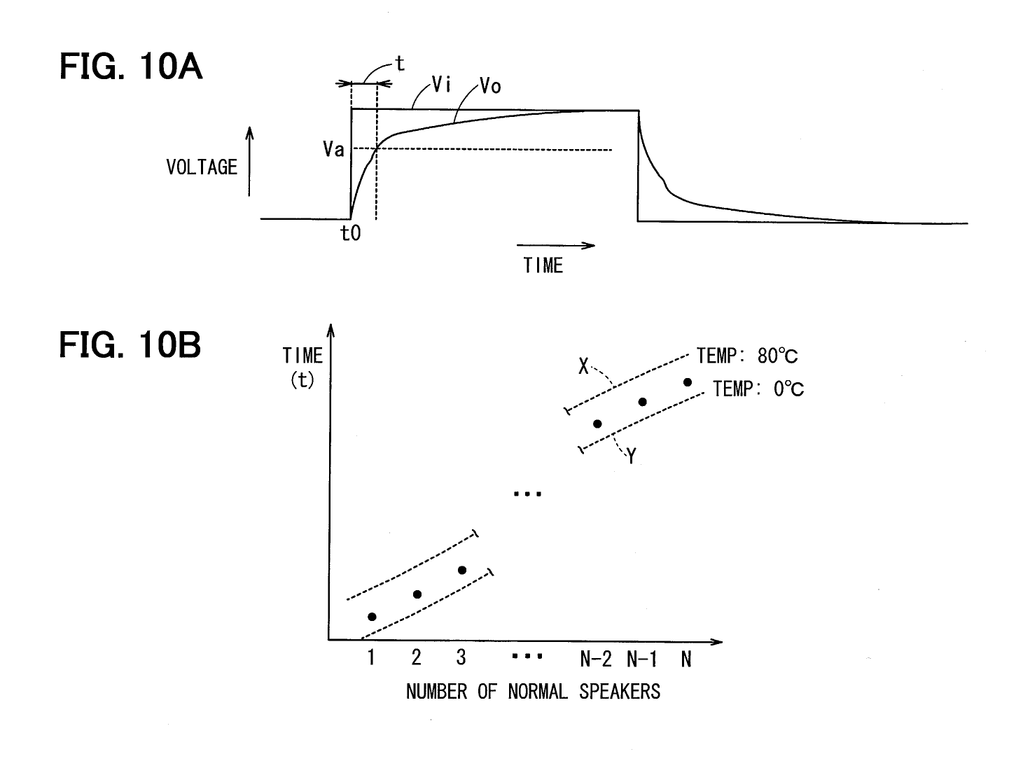

A fourth embodiment will be explained with reference to FIG. 10.

In the third embodiment, the temperature correction technique is applied to the technique according to the first embodiment.

In the fourth embodiment, the temperature correction technique is applied to the technique according to the second embodiment.

Similar to the third embodiment, in the fourth embodiment, the determination index value for the line break determination is corrected based on the detected temperature of the speakers 1 detected by the thermistor 11.

Specifically, the temperature correction unit 6b according to the fourth embodiment increases the determination index value when the temperature of the speakers 1 is reduced, as shown on a broken line X in FIG. 10B. The temperature correction unit 6b decreases the determination index value when the temperature of the speakers 1 is increased, as shown on a broken line Y in FIG. 10B.

The operation of the apparatus according to the fourth embodiment will be explained with reference to FIG. 10.

When the line break detection condition is satisfied, the line break detector 2 applies the reference voltage Vi to the speakers 1 via the digital amplifier 3, as shown in FIG. 10A.

Thus, similar to the second embodiment, the line break determination device 6 measures the time t, at which the actual voltage Vo detected by the voltage measurement device 5 reaches the predetermined voltage Va, from the time t0, at which the reference voltage Vi is applied to the speakers 1 with using the digital amplifier 3.

Then, as shown in FIG. 10B, the line break determination device 6 obtains the number of normal speakers 1 by comparing the measured time t with the determination index value corrected by the detected temperature.

In the fourth embodiment, the effects similar to the third embodiment are obtained.

(Modifications)

In the fourth embodiment, similar to the third embodiment, the determination index value is corrected according to the temperature of the speakers 1. Alternatively, the measurement value such as the time t to be used for the determination of the number of broken lines may be corrected according to the temperature of the speakers 1.

In this case, the effects similar to the third embodiment are obtained.

In the fourth embodiment, the temperature correction technique is applied to the technique for obtaining the number of broken lines with using the time t in the beginning of the energization to the speakers 1.

Alternatively, the temperature correction technique may be applied to the technique for obtaining the number of broken lines with using the time t in the time of stoppage of energization to the speakers 1.

In this case, the effects similar to the third embodiment are obtained.

### Fifth Embodiment

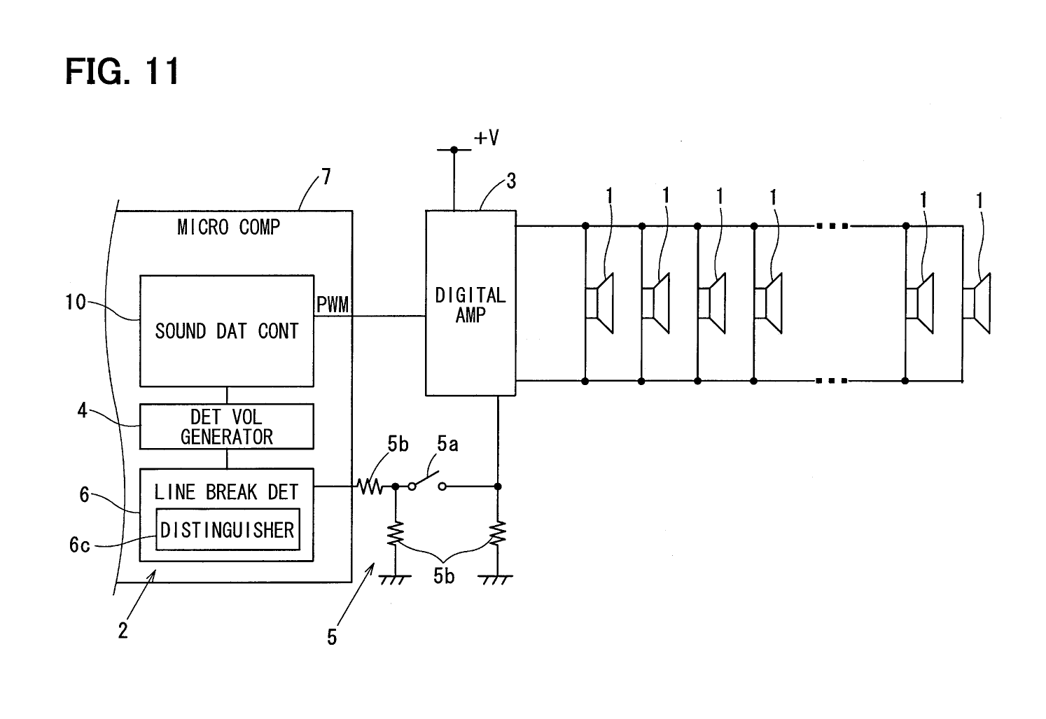

A fifth embodiment will be explained with reference to FIG. 11.

The line break determination device 6 includes a distinguishing element 6c, which stores the measurement value to be used for the determination of the number of broken lines in a storing element such as the memory in the micro computer. Further, the distinguishing element 6c compares the previous measurement value stored in the memory with the current measurement value measured currently, so that the element 6c distinguishes the line break from deterioration of a line caused by temporal change according to the difference between the previous measurement value and the current measurement value.

Specifically, the distinguishing element 6c provides a control program in the line break determination device 6. The ratio of Vo/Vi or the time t used for the determination of the number of broken lines is stored in the memory as the previous measurement value every time the line break process is executed.

Even time the line break process is executed, the distinguishing element 6c compares the current measurement value (i.e., the currently measured ratio of Vo/Vi or the currently measured time t) with the previous measurement value (i.e., the previously measured ratio of Vo/Vi or the previously measured time t).

The distinguishing element 6c determines that the line break occurs when the deterioration degree (i.e., the difference) between the current measurement value and the previous measurement value is larger than a predetermined deterioration threshold. The distinguishing element 6c determines that the line deteriorates with time when the deterioration degree (i.e., the difference) between the current measurement value and the previous measurement value is equal to or smaller than the predetermined deterioration threshold.

In the fifth embodiment, the apparatus determines whether the deterioration of the speakers 1 is caused by the line break or the deterioration with time.

Here, the fifth embodiment may be applied to one of the first to fourth embodiments.

In the above embodiments, the apparatus detects the number of broken lines in the speakers 1 for generating the audible sound. Alternatively, the apparatus may detect the number of broken lines in a speaker for generating an ultrasonic wave, which is suitably used for a parametric speaker.

In the above embodiments, multiple speakers 1 generate the alert sound. Alternatively, in addition to the speakers 1, the horn 8 may generate the alert sound.

The driving device for driving the speakers 1 is the digital amplifier 3. Alternatively, the driving device may be a class-B amplifier.

In the above embodiments, the vehicle existence alert apparatus includes the line break device 2. Alternatively, other acoustic apparatus may include the line break device 2.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An acoustic apparatus comprising:
a plurality of speakers, which are connected in parallel to each other; and
a line break detector for detecting the number of line break in the speakers,
wherein the line break detector includes:
a detection voltage generator for applying a reference voltage to the speakers; and
a line break determination device for determining the number of line break according to an actual voltage of the speakers when the reference voltage is applied to the speakers or when application of the reference voltage to the speakers is stopped.

2. The acoustic apparatus according to claim 1,
wherein each speaker is a capacitive speaker for generating a sound wave according to accumulation voltage change,
wherein the reference voltage is a direct current voltage for saturating a total capacitance of all speakers.

3. The acoustic apparatus according to claim 1, further comprising:
a digital amplifier for driving the speakers based on an input signal having a PWM waveform, which is input into the digital amplifier,
wherein the detection voltage generator applies a wave-height voltage having the PWM waveform to the digital amplifier so that the digital amplifier generates the reference voltage.

4. The acoustic apparatus according to claim 1,
wherein the line break determination device determines the number of line break according to the actual voltage of the speakers, which is measured at time after predetermined time has elapsed since the reference voltage was applied to the speakers, or after the predetermined time has elapsed since the application of the reference voltage to the speakers was stopped.

5. The acoustic apparatus according to claim 1,
wherein the line break determination device determines the number of line break according to a time interval between time, at which the actual voltage reaches a predetermined voltage, and time, at which the reference voltage is applied to the speakers, or the application of the reference voltage to the speakers is stopped.

6. The acoustic apparatus according to claim 1,
wherein the line break determination device detects temperature of the speakers directly or indirectly, and
wherein the line break determination device corrects a measurement value for determination of the number of line break or a determination index value for the determination of the number of line break according to the temperature of the speakers.

7. The acoustic apparatus according to claim 1,
wherein the line break detector further includes a memory,
wherein the line break determination device stores a measurement value for determination of the number of line break in the memory,
wherein the line break determination device includes a distinguishing element,
wherein the distinguishing element compares a currently detected measurement value with a previously detected measurement value stored in the memory, and
wherein the distinguishing element distinguishes the line break from a deterioration of a line with time based on a difference between the currently detected measurement value and the previously detected measurement value.
